(19) United States
(12) Patent Application Publication
(10) Pub. No.: US 2003/0190107 A1
(43) Pub. Date: Oct. 9, 2003

(54) Optical modulator with pre-determined frequency chirp

(76) Inventor: Robert Graham Walker, Northampton (GB)

Correspondence Address: Fleshner & Kim, PO Box 221200, Chantilly, VA, 20153-1200, US

(21) Appl. No.: 10/240,796

(22) PCT Filed: Mar. 21, 2001
(86) PCT No.: PCT/GB01/01246

(30) Foreign Application Priority Data
Apr. 6, 2000 (GB) 00085365
Aug. 2, 2000 (GB) 00188029

(51) Int. Cl. G02F 1/035

(52) U.S. Cl. 385/2

(57) ABSTRACT

An optical modulator for producing a modulated optical output having a pre-determined frequency chirp comprises: optical splitting means for receiving and splitting an optical input signal to be modulated into two optical signals to pass along two waveguide arms (36, 38) made electro-optic material; and optical combining means for receiving and combining the two optical signals into said modulated optical output. At least one electrode pair (40/44, 42/44) is associated with each waveguide arm (36, 38), and is electrically connected in series such as to modulate the phase of said optical signals in antiphase in response to a single electrical signal (V_{mod}) applied thereto. The modulator is characterised by a capacitive element (60) connected to the electrode pair (42) of one arm (38) such as to modify the division of the single electrical signal (V_{mod}) such that the magnitude of the electrical signal across the electrode pail (42/44) of one arm (38) is different to that across the electrode pair (40/44) of the other arm (36) thereby imparting the pre-determined frequency chirp in the modulated optical output.

This invention relates to an optical modulator with a pre-determined frequency chirp and more especially, although not exclusively, to an electro-optic Mach-Zehnder optical modulator or directional coupler with a pre-determined frequency chirp for use in an optical communications system.

As is known chromatic dispersion is a fundamental property of any waveguiding medium, such as for example the optical fibre used in optical communications systems. Chromatic dispersion causes different wavelengths to propagate at different velocities and is due to both the properties of the material medium and to the waveguiding mechanism.

In a communications system it is fundamental that modulation onto a carrier wave of a stream of digital or analogue data to be communicated causes diversification of the frequency of the carrier into one or more side-bands. Chromatic dispersion in a long optical fibre therefore causes progressive deterioration of the data with distance as the side-bands become phase shifted relative to each other. Chromatic dispersion has the effect of broadening or spreading pulses of data which limits the operating range and/or operating data rate of an optical fibre communications system.

In optical communications it is known to modulate an optical carrier using (i) direct modulation of the optical source, most typically a semiconductor laser, or (ii) external modulation in which the optical source is operated continuously and its light output modulated using an external modulator. In direct modulation the drive current to the laser is modulated thereby changing the refractive index of the active region which produces the required intensity modulation of the light output and additionally an associated optical frequency modulation. The associated optical frequency modulation is known as chirp. Quantitatively, the chirp parameter ax is defined by the expression:

$$Chirp Parameter \text{:} α = 2 I [ \frac{\frac{\partial φ}{\partial t}}{\frac{\partial I}{\partial t}} ] \qquad \text{Eq. 1}$$

where is I is the intensity,

the rate of change of optical phase φ and

the rate of change of intensity. Laser chirp further limits the operating range and/or data rate in optical communications due to chromatic dispersion. Since semiconductor lasers are generally prone to chirp strongly it is preferred to use external modulation, particularly using electro-optic interferrometric modulators, in long-haul high bit rate intensity-modulated optical fibre communications. A particular advantage of external modulators, particularly Mach-Zehnder modulators, are that (i) their chirp is low or zero, (ii) they can operate at much higher modulation frequencies (in excess of 100 GHz has been demonstrated), (iii) their light/voltage characteristic is well defined and has an odd-order symmetry which eliminates even-order harmonic distortion products and (iv) since the light source is run continuously at high stable power its light output is high and has spectral purity making it ideally suited to Wavelength Division Multiplex (WDM) systems.

Although optical modulators can modulate an optical signal with zero chirp and thereby minimise the effect of optical fibre chromatic dispersion, the operating range and/or data rates of long-haul fibre-optic communications is still limited by chromatic dispersion. To overcome this problem and to give optimum system performance it has been proposed to apply, using the modulator, a small and well controlled negative chirp to compensate for the fibre dispersion (A H Gnauk et al “dispersion penalty reduction using optical modulators with adjustable chirp” TFF.P. Photon. Technol. Lett. vol 3 (1991)). Negative chirp is obtained when a rising light level is combined with an optical frequency down-shift due to a net refractive index increase in the modulator (higher refractive index leads to a slower propagation which leads to an increased phase lag and lower frequency) and vice versa. The optimum value for the negative chirp parameter depends on the type and length of the optical fibre and is typically in the range α=−0.5 to −1.0.

The method of imparting negative chirp depends on the type of modulator. Modulators can broadly be characterised as those which are electro-absorptive or electro-refractive in nature.

Electro-absorptive devices utilise a change of material transparency near the bandgap wavelength of a semiconductor material and provide simple ON/OFF gating with non-linear characteristic. Since light is absorbed in a reverse-biased junction-region they are prone to electrical avalanching with potential for run-away at high optical power. There are powerful electro-refractive effects associated with the electro-absorption, which results in a high degree of chirp. They are also highly wavelength specific.

Electro-refractive, often termed electro-optic, modulators use an electric-field induced refractive index change that is a property of certain materials. They are usually based on interferometers and can utilise monolithic, planar, optical guided-wave technology to confine the light to the vicinity of the modulating electric field for distances of up to several centimetres so that the rather weak electro-optic effects can accumulate. Light is not absorbed in the OFF state but rather it is re-routed to an alternative port. Optical modulators of this class, which includes directional couplers, are of interest, not only for modulation, but also for optical switching and for signal processing in optical communications systems.

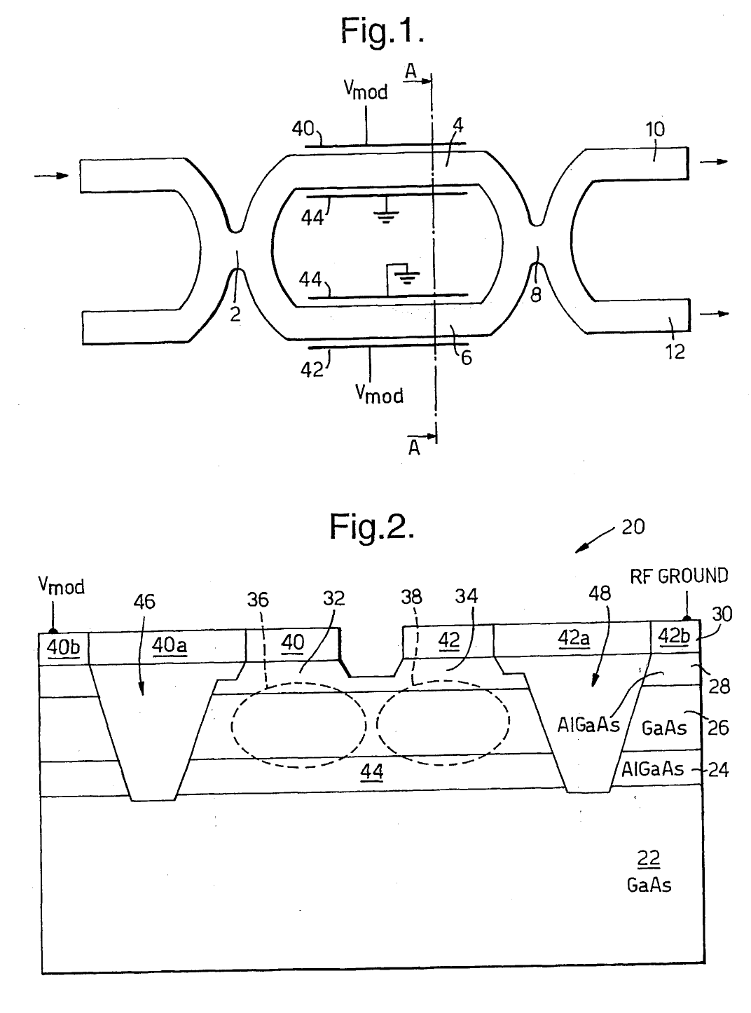

The predominant type of electro-optic optical modulator uses the Mach-Zehnder interferometer configuration as shown schematically in FIG. 1. A Mach-Zehnder optical modulator comprises an optical splitter 2 which splits light applied to an input 4 such that equal portions of light pass along two waveguide arms 6, 8 and to a recombiner 10 which recombines the light to produce an output at one of two outputs 12, 14. Each arm 6, 8, which is made of an electro-optic material, is provided with one or more modulation electrodes to impart a selectable phase shift to light passing along the arm.

As is known, electrically induced relative phase-shifts of ±90° between the arms 6, 8 cause the light to switch wholly to one or other of two the outputs 12, 14 upon recombination in the recombiner 10. The light transmission versus modulation voltage V_{mod} response has a periodic, raised-cosine form.

Intensity-modulation arises from the action of the recombiner 10 on the difference between the phase modulation on the different arms 6, 8 of the interferometer. Any net phase modulation at the outputs 12, 14 arises from that which they have in common and is the same at both outputs. The chirp parameter for a Mach-Zehnder modulator is defined for small excursions about the near-linear (50:50) working point by:

$$Mach \text{-} Zehnder Chirp \text{:} {α}_{MZ} = \frac{{V}_{L1} + {V}_{L2}}{{V}_{L1} - {V}_{L2}} \qquad \text{Eq. 2}$$

where V_{L1} is the voltage length product for the first waveguide arm 6 and V_{L2} is the voltage length product for the second waveguide arm 8. The voltage length product includes sign.

From a limited source of total phase modulation the differential and common phase modulation components are in competition. Consequently an intensity modulator with residual phase modulation (chirp) will be less efficient in other respects than a comparable zerohirp device.

As is now described, a Mach-Zehnder modulator can be operated in different ways. In a first drive method, termed Single-Sided Drive, a single R modulating drive voltage V_{mod} is applied to the modulation electrode of one arm only. This gives a chirp parameter of ±1. The RF drive voltage can be considered as being equivalent to a differential voltage of ±V_{mod}/2 which is superposed on a common level of V_{mod}/2 and results in the chirp parameter being non zero. Intensity modulation is proportional to V_{mod} and the RF power required to drive the modulator is proportional to V²_{mod}.

In a second drive method, termed dual-drive push-pull, independent, equal and opposite RF drive voltages of ±V_{mod}/2 are applied respectively to the two arms. This drive method yields zero chirp and an intensity modulation proportional to V_{mod}. The RF drive power required is proportional to V²_{mod}/4+V²_{mod}/4—i.e. half that of a single-sided drive.

In a third drive method, termed Series Push-Pull, the drive electrodes of the two arms are series-connected and driven with a single RF drive voltage V_{mod}. Half the drive voltage appears across each arm, and they work in antiphase to give the same intensity modulation as both of the above drive methods but with no chirp. The RF power requirement is the same as that of the single-sided drive but the modulator will have about twice the bandwidth since the capacitance presented to the RF source is halved.

Finally, in a fourth drive configuration known as Parallel Push-Pull the drive electrodes of the two arms are cross-connected in parallel and driven from a single RF source drive voltage V_{mod}/2. In this configuration the arms work in antiphase to give the same intensity modulation as the drive methods described above with no chirp. The RF power requirement for this drive method is now only one quarter of that of the single-sided method. However the capacitance presented to the RF source is double that of the single-sided drive so the modulator will have about half the bandwidth.

Table 1 below summarises, for the different drive methods described, their chirp parameter, bandwidth and power. In the table all the figures are normalised to the single-sided drive method. It is worth noting that the required drive-voltage and the bandwidth can be traded against each other in an electro-optic modulator design since both are inversely proportional to the length of the drive electrode. However, in terms of the ratio of Bandwidth to Power (a Figure of Merit) a chirp-factor of unity will always cost [symbol] a factor of two.

TABLE 1
Chirp parameter, power, bandwidth and intensity modulation “FIGURE
of Merit” for various Mach-Zehnder modulator Drive Methods.

| Drive Method | Chirp | Power | Bandwidth BW | BW: Power |
|---|---|---|---|---|
| single-sided | ±1 | 1 | 1 | 1 |
| dual-drive push-pull | 0 | ½ | 1 | 2 |
| series push-pull | 0 | 1 | 2 | 2 |
| parallel push-pull | 0 | ¼ | ½ | 2 |

A particularly preferred form of modulator for use in optical communication is a Mach-Zehnder modulator fabricated in GaAs/AlGaAs. This type of modulator, for reasons of fabrication, has an inherent built-in electrical back-connection between the two waveguide arms in the form of an n-type doped semiconductor material just beneath the waveguides which is necessary to confine the applied electric field to the guided-wave regions. Thus, the native drive method of GaAs/AlGaAs electro-optic modulators is series push-pull and consequently such a modulator design cannot, without modification, impart chirp.

A development of the above type of optical modulator which is particularly preferred in high speed optical communications is a travelling-wave GaAs/AlGaAs electro-optic modulator. As is known, this type of modulator is a Mach-Zehnder modulator in which the modulation electrode is segmented into a number of electrodes that are disposed along the length of each waveguide arm. The modulating voltage is applied to the electrode segments using a coplanar transmission line from which the electrodes depend and propagates in the form of a travelling RF wave in the same direction as the optically guided wave. The electrode segments in turn provide capacitive loading to the transmissionline which thereby acquires slow-wave properties. By appropriate selection of the loaded line, the phase velocity of the travelling RF modulating voltage and the group velocity of the optically guided wave can be precisely matched such that the modulation accumulates monotonically over the length of the waveguiding regions. This results in a much higher degree of optical modulation than is otherwise possible with a standard Mach-Zehnder modulator. Like standard GaAs/AlGaAs electro-optic modulators these devices have an inherent back-connection between the two arms and are consequently driven in is series push-pull and cannot impart chirp.

Whilst it would, in theory, be possible to apply different modulating drive voltages to the two arms to impart a desired chirp, in practical applications, especially the highest bit rate communications systems, it is impractical and undesirable to do so. For example, separate modulating drive voltages requires two well-matched RF sources or a very well-balanced RF splitter which is impracticable at very high bit rates of tens of giga bits per second. Additionally, the use of separate drive voltages in a very high frequency travelling-wave structure is impractical since it would require dual transmission-drive lines which would require the modulator to be much larger to prevent coupling of the drive signals between the lines. Such coupling would compromise the flatness of the modulator's frequency response.

It has also been proposed to asymmetrically displace the modulating electrodes relative to the waveguide arms in a lithium niobate Mach-Zehnder modulator to imbalance the electro-optic efficiency between the arms and so impart a fixed amount of chirp (P Jiang and A O'Donnell “LibO₃ Mach-Zehnder Modulators with fixed Negative Chirp”, IEEE Photonics Tech. Lett., Vol. 8 (10), 1996). As is known, in a lithium niobate modulator it is the fringing electric fields from the co-planar electrodes which are placed adjacent to the in diffused waveguides which gives rise to the electro-optic effect. This technique of imparting chirp is only appropriate to modulators in which the modulating electrodes are not inherently in a fixed alignment with the optical waveguides and is consequently not appropriate to GaAs modulators in which the electrodes and waveguides possess an inherent alignment due to the fabrication process.

A need exists therefore for an optical modulator which is capable of imparting a pre-determined amount of frequency chirp, preferably between zero and ±1, which in part alleviates the limitations of the known devices. The present invention has arisen in an endeavour to provide a GaAs/GaAlAs Mach-Zehnder electro-optic modulator which is capable of imparting a pre-determined frequency chirp.

According to the present invention an optical modulator for producing a modulated optical output having a pre-determined frequency chirp comprises: optical splitting means for receiving and splitting an optical input signal to be modulated into two optical signals to pass along two waveguide arms made of electro-optic material; optical combining means for receiving and combining the two optical signals into said modulated optical output; at least one electrode pair associated with each waveguide arm, said electrode pairs being electrically connected in series such as to modulate the phase of said optical signals in anti-phase in response to a single electrical signal applied thereto; characterised by a capacitive element connected to the electrode pair of one arm such as to modify the division of the single electrical signal such that the magnitude of the electrical signal across the electrode pair of one arm is different to that across the electrode pair of the other arm thereby imparting the predetermined frequency chirp in the modulated optical output.

The provision of the capacitive element enables the optical modulator of the present invention to achieve a chirp parameter of between 0 and ±1 and can be considered as being driven in a manner which is intermediate between a single-sided and push-pull drive configuration.

It will be appreciated that the provision of a capacitive element to impart a pre-determined frequency chirp can be applied to any electrooptic device having two or more waveguides in which the refractive index of one waveguide is altered relative to that of the other waveguide in response to an electrical signal. As such the present invention also applies to other forms of optical modulators and more especially to a directional coupler when it is operated as a modulator rather than a switching device.

Thus according to a second aspect of the invention an optical modulator for producing a modulated optical output having a predetermined frequency chirp comprises: two optical waveguides of electro-optic material which are located adjacent to each other such as to allow optical coupling between the waveguides and at least one, electrode pair associated with each optical waveguide, said electrode pairs being electrically connected in series such as to de-synchronise the coupling between the waveguide in anti-phase in response to a single electrical signal applied to the electrode pairs; characterised by a capacitive element connected to the electrode pair of one waveguide such as to modify the division of the single electrical signal such that the magnitude of the electrical signal across the electrode pair of one waveguide is different to that across the electrode pair of the other waveguide thereby imparting a predetermined frequency chirp in the optical output.

Advantageously the capacitive element is connected in parallel with the electrode pair of said arm and the single electrical signal is applied to the electrode pairs in a series push-pull configuration. Alternatively the capacitive element is connected in series with the electrode pair of said arm and the electrical signal is applied to the electrode pairs in a parallel push-pull configuration.

The present invention applies to both lumped and travelling-wave implementations. Thus one embodiment comprises a plurality of electrode pairs positioned along each waveguide arm; a respective capacitive element connected to each electrode pair of one arm and a transmission line associated with each arm to which the electrode pairs are electrically connected, wherein the electrode pairs are positioned such that the phase velocity of the electrical signal as it travels along the transmission line is substantially matched to the optical group velocity of the optical signals.

In a preferred implementation, the optical modulator is fabricated in III-V semiconductor materials such as GaAs and AlGaAs. Alternatively it can be fabricated in any electro-optic medium.

Conveniently the, or each, capacitive element comprises an additional electrode pair which is provided across a material layer used to guide the optical signals in the modulator and wherein said additional electrode pair is located on a region of said material such that it does not substantially affect the phase of optical signal passing through the associated waveguide arm.

According to a third aspect of the invention. An optical modulator for producing a modulated optical output signal having a predetermined frequency chirp comprises: optical splitting means for receiving and splitting an optical input signal to be modulated into two optical signals to pass along two waveguide arms made of electro-optic material; optical combining means for receiving and combining the two optical signals into said modulated optical output; a plurality of electrode pairs associated with each waveguide arm and positioned along each waveguide arm for differentially modulating the phase of light passing along one waveguide arm relative to that of the other waveguide arm in response to a single electrical signal applied to the electrode pairs and a transmission line associated with each arm to which these electrode pairs are electrically connected, wherein respective electrode pairs on each waveguide arm are electrically connected in series and are connected to the transmission line such that the phase velocity of the electrical signal as it travels along the transmission line is substantially matched to the optical group velocity of the optical signals; characterised by one or more selected electrode pairs being displaced from its associated waveguide such that the or each electrode pair does not substantially affect the phase of the optical signal such as to obtain a the pre-determined chirp in the modulated optical output.

Conveniently one electrode of each selected electrode pair is laterally displaced relative to its associated waveguide such that the phase of the optical signal passing through said waveguide is substantially unaffected by the displaced electrode but wherein the electrical properties of the electrode pair are substantially identical to those of other electrode pairs which have not been displaced.

Preferably the optical modulator is fabricated in a III-V semiconductor material such as GaAs and AlGaAs. Alternatively it can be fabricated in any electro-optic medium.

In order that the invention may be better understood three optical modulators in accordance with the two aspects of the invention will now be described by way of example only with reference to the accompanying drawings in which:

FIG. 1 is a schematic representation of a known Mach-Zehnder optical modulator in plan view;

FIG. 2 is a schematic sectional end view of a known Mach-Zehnder optical modulator fabricated in GaAs/GaAlAs through the line ‘AA’ of FIG. 1;

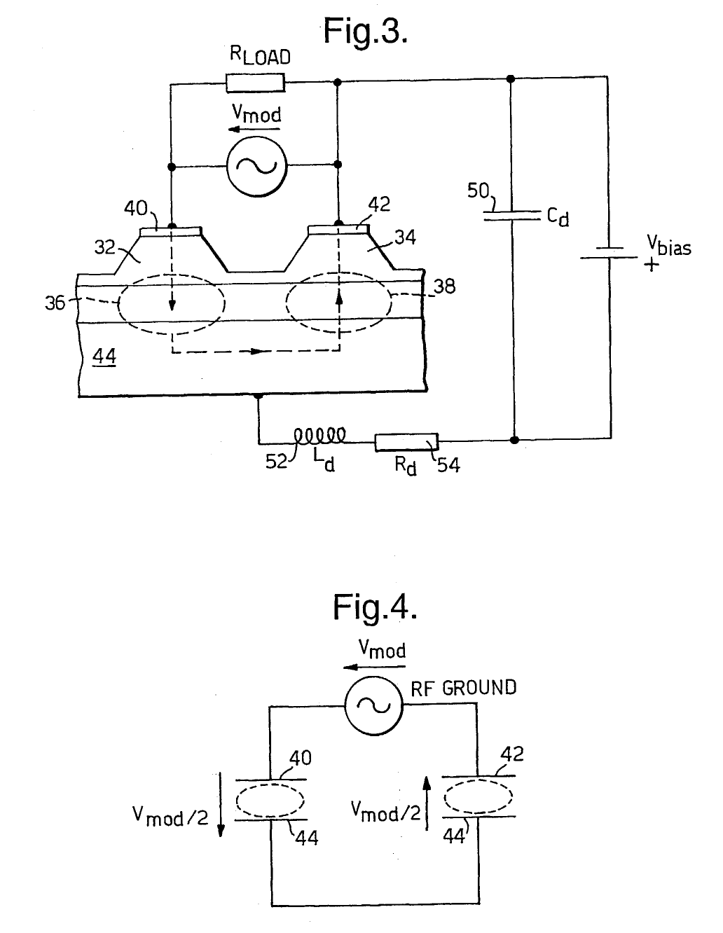

FIG. 3 is a diagram of the drive circuitry for the modulator of FIG. 2;

FIG. 4 is an a.c. equivalent circuit of the drive circuitry and modulator of FIG. 3;

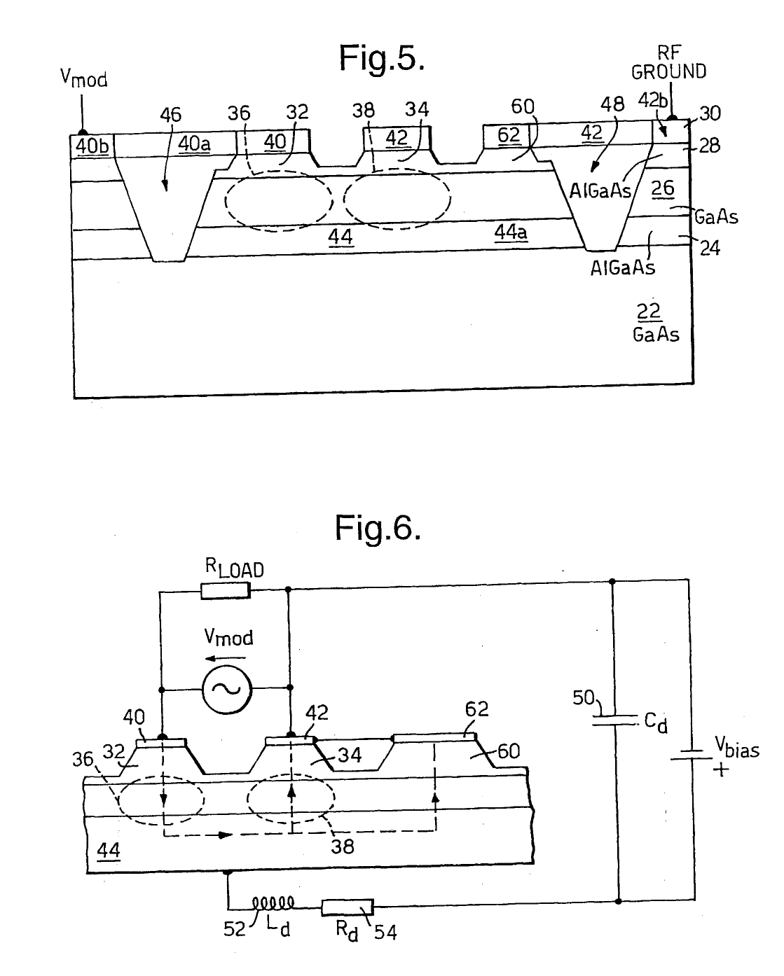

FIG. 5 is a schematic sectional end view of an optical modulator in accordance with a first aspect of the invention through the line ‘BB’ of FIG. 8;

FIG. 6 is a diagram of the drive circuitry for the modulator of FIG. 5

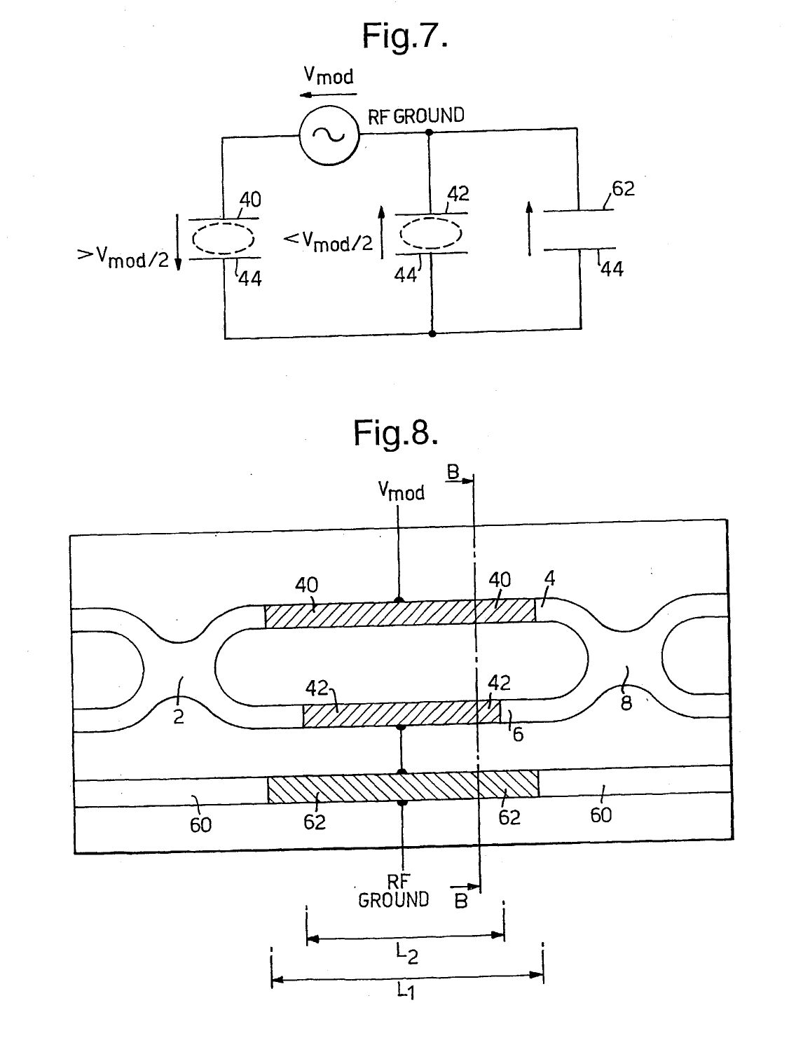

FIG. 7 is an a.c. equivalent circuit of the modulator and drive circuitry of FIG. 6;

FIG. 8 is a schematic plan view of the modulator of FIG. 5 showing the modulating electrodes and capacitive element electrode;

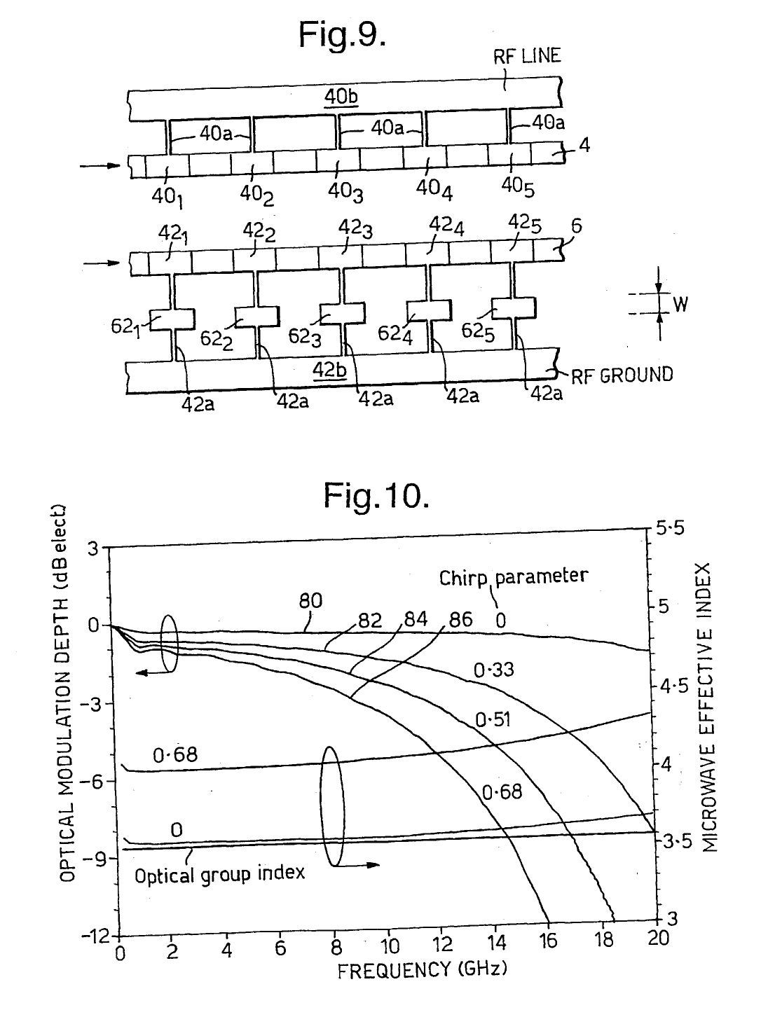

FIG. 9 is a schematic representation, in plan view, of a traveling-wave optical modulator in accordance with a first aspect of the invention;

FIG. 10 is a plot of optical modulation depth versus frequency for various pre-determined chirp parameters for the optical modulator of FIG. 9;

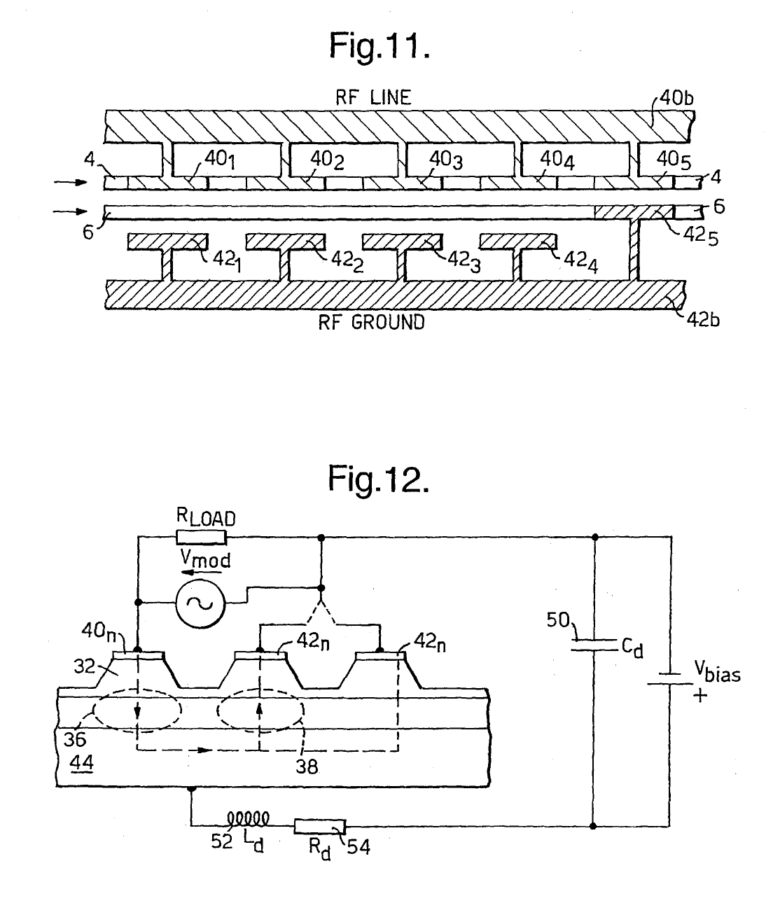

FIG. 11 is a schematic representation, in plan view, of a travelling-wave optical modulator in accordance with a second aspect of the invention;

FIG. 12 is sectional end view through the optical modulator of FIG. 11 including drive circuitry; and

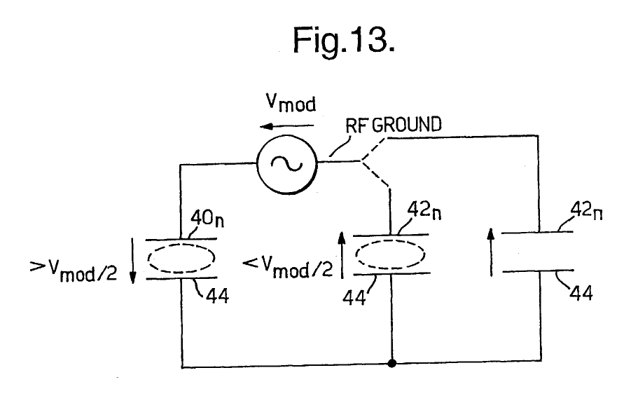

FIG. 13 is an a.c. equivalent circuit of the modulator and drive circuitry of FIG. 12.

To assist in understanding the optical modulators of the present invention it is helpful to firstly describe the known Mach-Zehnder optical modulator as fabricated in GaAs/AlGaAs. A sectional end view through the line ‘AA’ of FIG. 1 of such a modulator is shown in FIG. 2. The optical modulator 20 comprises in order an undoped (semi-insulating) Gallium Arsenide (GaAs) substrate 22, a conductive doped n-type Aluminium Gallium Arsenide (AlGaAs) layer 24, a further layer of undoped Gallium Arsenide 26, a further layer of undoped AlGaAs 28 and a metallic conductive layer 30. The GaAs layer 26 provides the optical waveguides medium with the refractive index contrast between the AlGaAs layers 24 and 28 and GaAs layer 26 providing vertical confinement thereby constraining light to propagate within the layer 26. The optical waveguide arms (4, 6 see FIG. 1) of the modulator are defined within the GaAs layer 26 which are selectively etched into the AlGaAs layer 28 two mesas (plateau region) 32, 34. The mesas 32, 34 provide an in-plane effective refractive-index contrast that confines the light to a region beneath the mesa. As shown in FIG. 2 light is confined to two parallel paths, the waveguide arms, which pass into the plane of the paper as illustrated and which are denoted by the broken line 36, 38. The metallic layer 30 is appropriately patterned to overlay the mesas 32, 34 and constitutes the respective modulation electrodes 40, 42 of each waveguide arm. The electrodes 40,42 run the length of the waveguide arms.

Since it is intended to drive the modulator using a series-push-pull method, it is required that the back plane electrode, which is constituted by a region 44 of the conductive n-doped AlGaAs layer 24, is free to float to the mid-point of the RF modulating voltage and is not pinned to a ground potential. To ensure this is the case the two trenches 46, 48 are etched through the layers 24, 26, 28 and run parallel with the axis of the waveguide arms. To ensure good electrical isolation of the backplane electrode 44 the isolation trenches 46, 48 are etched a small distance into the semi-insulating GaAs substrate 22. Electrical connection to the modulator electrodes 40, 42 is made by stranded thin film metal structures 40a, 42a in the conducting metalisation layer 30, which form air bridges over the isolation trenches 46, 48 to respective modulation drive voltage lines 40b, 42b. As shown in FIG. 2 the left hand modulation drive voltage line 40b comprises an RF modulating drive line and the right hand line 42b the RF modulating drive voltage ground.

Referring to FIG. 3 there is shown drive circuitry for operating the optical modulator of FIG. 2. To enable a dc bias potential to be applied to the backplane electrode 44 whilst still allowing the backplane to float at the RF modulation frequencies a dc-coupling capacitor C_{d} 50, inductor L_{d} 52 and drive resistor R_{d} 65 are connected as shown in the diagram. In practice the capacitor 50 is realised by a Schottky contact metalisation while the inductor L_{d} 52 and drive resistor R_{d} 65 are realised as narrow trench-isolated regions of the lead-in or lead-out waveguide runs which do not include modulating electrodes. As seen in FIG. 3 the modulating RF voltage V_{mod} is applied to the modulating electrodes 40, 42 in series whilst the bias voltage is applied in a parallel configuration. This drive arrangement ensures that the reverse bias conditions across the depletion layer (i.e. across layers 24, 26, 28) of the device are maintained throughout the cycle of the RF modulating voltage.

Referring to FIG. 4 there is shown the ac equivalent electrical circuit for the modulator and drive circuitry of FIG. 3. The modulating electrodes 40, 42 and backplane electrode 44 in conjunction with the semi-insulating GaAs and AlGaAs layer 26, 28 are electrically equivalent to two serially connected capacitors 56, 58 and hence the reason why the drive configuration is termed series push-pull.

Referring to FIG. 5 there is shown an optical modulator in accordance with a first aspect of the invention which is capable of applying a selected amount of frequency chirp to the optical signal it modulates. The structure is in essence the same as that already described with references to FIG. 2 but further includes an additional mesa structure 60 formed within the AlGaAs layer 28. The structure 60 is identical to each of the mesa 32, 34 however the region of the GaAs layer 36 underlying the structure but is not optically connected to the waveguide arms and therefore never guides light. The structure 60 runs parallel with and is the length of the modulating electrode 42. The metalisation layer 62 on top of the structure constitutes a first electrode which in conjunction with the underlying backplane electrode 44a constitutes a passive capacitance element. Electrically the capacitance element is identical to the capacitor constituted by the modulating electrodes/backplane electrode. This electrode 62 is electrically connected to the modulating electrode 42. As will be appreciated with reference to FIG. 6 this additional capacitive element 60, 62 is electrically equivalent to a capacitance connected in parallel with the capacitance of the right hand waveguiding arm. As noted above no light is guided in the GaAs 26 underlying the electrode 26 and therefore optically the symmetry of the modulator is unaffected. Since the capacitive element has no direct effect on the optical signals passing along the waveguide arms it will hereinafter be termed a passive capacitor element.

As can be seen from FIG. 7 the addition of the passive capacitive element 70 is parallel with the modulating electrode of one arm has the effect of reducing the reactance of the arm. As a result, a reduced fraction of the modulating voltage will appear across this arm of the modulator while a correspondingly increased fraction appears across the other.

Accordingly the electro-optic phase shifts applied to the optical signal passing along the first (right hand in FIG. 7) arm will be reduced while that of the optical signal passing along the other arm is increased. As a result of the now unbalanced differential phase shift, a predetermined amount of phase modulation remains on the optical signal output when the two optical signals are recombined. This translates to frequency chirp. Since the capacitive element is passive the amount of chirp will be fixed and is dependent on the capacitance of the element.

Referring to FIG. 8 there is shown in plan view, the modulating electrodes 40, 42 and electrode 62 of the passive capacitive element; it will be appreciated that the capacitance per unit length for each electrode is dependent upon the width of the electrode. The capacitance of the passive capacitive element can be modified by the width of the electrode 62. Optionally, as shown in FIG. 8 the length of the modulating electrode 42 and electrode 62 can be made unequal to reduce the size of the structure required for the capacitive element. From equation 2 above it can be shown that the chirp parameter for the applied modulator of FIG. 8 is given by:

$$\vert α \vert = \frac{1}{1 + 2 [ \frac{C}{{C}_{g}} - \frac{{L}_{2}}{{L}_{1}} ]} \qquad \text{Eq. 3}$$

where L₁ is the length of the electrodes 40, 62, L₂ is the length of the electrode 42, C the capacitance per unit length for the modulating electrodes 40, 42 and C_{g} the capacitance per unit length of the electrode 62. As is noted from equation 3 no chirp will be imparted when Cg=0 and this is irrespective of the relative lengths of the modulating electrodes L₁, L₂. This is because the optical modulator is self balancing with regard to the electrode length: a shorter modulating electrode has less capacitance and so, in the absence of Cg, acquires a greater proportion of the modulating RF voltage which thereby exactly compensates for a shorter length. The sign of the chirp is dependent upon the slope of the light/voltage characteristic and is positive at one of the two complementary outputs while it is negative at the other. The degree of chirp is selected primarily by means of the width of the passive element. In effect the additional capacitive element means that the modulator is driven in a way which is intermediate between a single sided and push-pull configuration and only requires a single RF modulating drive voltage.

Referring to FIG. 9, there is shown in plan view, a travelling-wave optical modulator in accordance with the first aspect of the invention. In this embodiment the modulating drive electrodes 40, 42 are divided into a number of discrete segments 40₁-40₅, 42₁-42₅ disposed along the length of each waveguide arm. In addition a segmented passive capacitive element 62₁-62₅ is provided and connected to the modulating drive electrodes 42₁-42₅ of one arm. Again this arrangement results in different amounts of the modulating RF voltage being dropped across the waveguide arms thereby enabling chirp to be imparted to the optical output.

Referring to FIG. 10, there is shown a plot of calculated optical modulation depth in decibels (dB) (left hand ordinate) and microwave effective index (right hand ordinate) versus frequency for a travelling-wave modulator having predetermined chirp parameters of 0, −0.33, −0.51, and −0.68 respectively. The line 80 denotes the case for a modulator with zero chirp, that is with no additional passive capacitive element. The lines 82, 84 and 86 are for an optical modulator having values of chirp of 0.33, −0.51 and −0.68 respectively. For each of these modulators the electrodes 62₁-62₅ of the passive capacitive element are of equal length and the differing chirp parameters are obtained by varying the width w of the electrode.

It will be appreciated by those skilled in the art that modifications can be made to the optical modulator described which are within the scope of the invention. For example whilst it is preferable to fabricate the modulator in GaAs/AlGaAs it can be fabricated in other III-V semiconductor materials or other electro-optic materials using appropriate fabrication techniques.

Furthermore whilst the present invention particularly concerns an electro-optic optical modulator it will be appreciated that the provision of the capacitive element to impart a pre-determined frequency chirp can be applied to other electro-optic devices having two or more waveguides in which the refrative index of one waveguide is altered relative to that of the other waveguide in response to an electrical signal. For example it is envisaged to apply the invention to an electro-optic directional coupler when it is operated as a modulator rather than a switching device. In such a device the two waveguides are located closely adjacent to each other such as to allow optical coupling between them. Electrodes are provided on each waveguide and are such that the application of the electrical signal to the electrodes in a push-pull configuration results in a de-synchronising of the coupling between the two waveguides due to the relative change in refractive index between the waveguides. This de-synchronsing results in a modulation of an optical signal passing along the or each waveguide. In accordance with the present invention a passive capacitive element is connected to the electrodes of one waveguide such as to modify the division of the electrical signal such that the magnitude of the electrical signal on one waveguide is different to that of the electrode of the other waveguide thereby imparting a pre-determined frequency chirp to the optical signal.

It will be further appreciated that whilst the capacitive element is described as being connected in parallel with the electrodes of one waveguide when the device is drive in series push-pull configuration it can alternatively be connected in series with the electrodes of one waveguide when using a parallel push-pull drive configuration. Furthermore it is also envisaged to use a variable capacitive element, such as an integrated varicap or varactor diode, such that the frequency chirp can be selectively adjusted by the application of an appropriate d.c. bias voltage.

Referring to FIGS. 11-13 there is shown a further travelling-wave optical modulator in accordance with a second aspect of the invention in which the desired frequency chirp is built up in a quantised or digital manner by combining single-sided with balanced push-pull elements. In FIG. 11 five modulating electrodes 40₁-40₅, 42₁-42₅ are shown on each waveguide arm 4, 6. For the first four modulating electrodes of each set of five, the ground side electrode 42₁-42₄ is displaced so that it is no longer overlays its respective waveguide arm 6. As a result these electrode elements 40₁-40₄, 42₁-42₄ are driven in a single sided manner and consequently impart a chirp parameter of ±1. In each fifth modulating electrode pair 40₅, 42₅, both electrodes overlay their respective waveguide arm 4, 6 and this set is therefore driven in a series push-pull configuration and consequently imparts zero chirp. By selecting the ratio of electrode segments which apply a chirp of ±1 with those that impart a chirp of zero it is possible to obtain a desired chirp parameter. An advantage of this configuration is that the RF symmetry of the standard push-pull modulator design is retained since the modulating electrode has been merely moved off the waveguide rather than an additional passive capacitance having been added. The displaced electrodes, hereinafter referred to as dummy electrodes, are of the same width as the modulating electrode which overly the waveguide, hereinafter referred to as active electrodes, to avoid any conflict in the RF potential of the material beneath the different types of electrode segments.

For modulators having a total of N active and dummy electrodes of which M have a push-pull configuration and N-M have a single sided drive arrangement the chirp parameter is given by:

$$α = \frac{N - M}{N + M} \qquad \text{Eq. 4}$$

Thus for the embodiment illustrated, in which N=5 and M=1, a chirp parameter of ±0.6667 is obtained. A particular advantage of this arrangement is that because the dummy electrodes have been created by merely displacing the ground side electrode away from the waveguide, electrically the arrangement is still essentially identical to that of a standard push-pull arrangement. Since the dummy electrodes discard half the RF modulating drive potential by dropping it across a non-active, dummy, waveguide section the drive voltage necessary to operate the modulator will increase. However since electrically the modulator is equivalent to a standard push-pull arrangement it retains all the benefits of its enhanced bandwidth. The provision of applying selective chirp is therefore only at the expense of a penalty in increased drive voltage rather than of reduced bandwidth as with the first invention.

1. An optical modulator for producing a modulated optical output having a pre-determined frequency chirp comprising: optical splitting means (2) for receiving and splitting an optical input signal to be modulated into two optical signals to pass along two waveguide arms (4,6) made of electro-optic material; optical combining means (8) for receiving and combining the two optical signals into said modulated optical output; at least one electrode pair (40, 42/44) associated with each waveguide arm (4, 6), said electrode pairs (40, 42/44) being electrically connected in series such as to modulate the phase of said optical signals in anti-phase in response to a single electrical signal (V_{mod}) applied thereto; characterised by a capacitive element (60, 62) connected to the electrode pair (42/44) of one arm (6) such as to modify the division of the single electrical signal (V_{mod}) such that the magnitude of the electrical signal across the electrode pair of one arm (6) is different to that across the electrode pair of the other arm (4) thereby imparting the pre-determined frequency chirp in the modulated optical output.

2. An optical modulator for producing a modulated optical output having a pre-determined frequency chirp comprising: two optical waveguides of electro-optic material which are located adjacent to each other such as to allow optical coupling between the waveguides and at least one, electrode pair associated with each optical waveguide, said electrode pairs being electrically connected in series such as to de-synchronise the coupling between the waveguide in anti-phase in response to a single electrical signal applied to the electrode pairs; characterised by a capacitive element connected to the electrode pair of one waveguide such as to modify the division of the single electrical signal such that the magnitude of the electrical signal across the electrode pair of one waveguide is different to that across the electrode pair of the other waveguide thereby imparting a pre-determined frequency chirp in the optical output.

3. An optical modulator according to claim 1 or claim 2 in which the capacitive element (60, 62) is connected in parallel with the electrode pair (42/44) of said arm (6) and in which the single electrical signal (V_{mod}) is applied to the electrode pairs in a series push-pull configuration.

4. An optical modulator according to claim 1 or claim 2 in which the capacitive element (60, 62) is connected in series with the electrode pair (42/44) of said arm and in which the electrical signal (V_{mod}) is applied to the electrode pairs in a parallel push-pull configuration.

5. An optical modulator according to any preceding claim and comprising a plurality of electrode pairs (40, 42/44) positioned along each waveguide arm (4, 6); a respective capacitive element (60, 62) connected to each electrode pair (42/44) of one arm (6) and a transmission line (40b, 42b) associated with each arm (4, 6) to which the electrode pairs (40, 42, 62) are electrically connected (40a, 42a), wherein the electrode pairs are positioned such that the phase velocity of the electrical signal as it travels along the transmission line is substantially matched to the optical group velocity of the optical signals.

6. An optical modulator according to any preceding claim and fabricated in III-V semiconductor materials.

7. An optical modulator according to claim 6 and fabricated in GaAs and AlGaAs.

8. An optical modulator according to any preceding claim in which the, or each, capacitive element (60) comprises an additional electrode pair (62/44) which is provided across a material layer (26) used to guide the optical signals in the modulator and wherein said additional electrode pair is located on a region of said material such that it does not substantially affect the phase of optical signal passing through the associated waveguide arm.

9. An optical modulator for producing a modulated optical output signal having a pre-determined frequency chirp comprising: optical splitting means (2) for receiving and splitting an optical input signal to be modulated into two optical signals to pass along two waveguide arms (4, 6) made of electro-optic material; optical combining means (8) for receiving and combining the two optical signals into said modulated optical output; a plurality of electrode pairs (401-405, 421-425/44) associated with each waveguide arm (4, 6) and positioned along each waveguide arm for differentially modulating the phase of light passing along one waveguide arm relative to that of the other waveguide arm in response to a single electrical signal (V_{mod}) applied to the electrode pairs and a transmission line associated (40b, 42b) with each arm to which these electrode pairs are electrically connected, wherein respective electrode pairs on each waveguide arm are electrically connected in series and are connected to the transmission line such that the phase velocity of the electrical signal as it travels along the transmission line is substantially matched to the optical group velocity of the optical signals; characterised by one or more selected electrode pairs (42₁-42₄) being displaced from its associated waveguide such that the or each electrode pair does not substantially affect the phase of the optical signal such as to obtain a the pre-determined chirp in the modulated optical output.

10. An optical modulator according to claim 9 in which one electrode (42₁-42₄) of each selected electrode pair is laterally displaced relative to its associated waveguide (6) such that the phase of the optical signal passing through said waveguide is substantially unaffected by the displaced electrode but wherein the electrical properties of the electrode pair are substantially identical to those of other electrode pairs which have not been displaced.

11. An optical modulator according to claim 9 or claim 10 and fabricated in a III-V semiconductor materials.

12. An optical modulator according to claim 11 and fabricated in GaAs and AlGaAs.
